(19) United States
(12) Patent Application Publication
(10) Pub. No.: US 2026/0181309 A1
(43) Pub. Date: Jun. 25, 2026

(54) Headphone Control Method and Headphone

(71) Applicant: Anker Innovations Technology Co., Ltd., Changsha (CN)

(72) Inventors: Jiasheng Li, Shenzhen (CN); Qi Li, Shenzhen (CN); Yushu He, Shenzhen (CN)

(21) Appl. No.: 19/425,789

(22) Filed: Dec. 18, 2025

(30) Foreign Application Priority Data
Dec. 24, 2024 (CN) 202411918843.X

(51) Int. Cl. H04R 1/10; G10K 11/178

(52) U.S. Cl. CPC H04R 1/1083; G10K 11/17815; G10K 11/17825; G10K 11/17827; G10K 2210/1081; G10K 2210/30232; G10K 2210/3026; G10K 2210/3027; G10K 2210/3028

(57) ABSTRACT

A method for improving the sound quality of a headphone is provided. The method comprises acquiring a first audio signal by a feed-forward microphone and acquiring a second audio signal by a feed-back microphone; and determining a scene type of a scene where the headphone is located based on the first audio signal. The method further comprises obtaining a target effect audio signal based on the scene type; and determining current spectrum relationship information between the first audio signal and the second audio signal, and target spectrum relationship information between the first audio signal and the target effect audio signal. The method also comprises adjusting filter parameters of the headphone according to the current spectrum relationship information and the target spectrum relationship information; and re-acquiring the second audio signal using the adjusted filter parameters.

### CROSS-REFERENCE TO RELATED APPLICATION

The present disclosure claims all the benefits of the Chinese patent application No. 202411918843.X filed on Dec. 24, 2024, which is incorporated herein by reference in their entirety.

### FIELD

The present disclosure relates to the technical field of sound processing, particularly a headphone control method and a headphone.

### BACKGROUND

With the development of audio processing technology, headphones can have a transparency mode and an active noise reduction mode. In the transparency mode, the headphones may transmit sound in the external environment to a user's ears; in the active noise reduction mode, the headphone may filter noise in the external environment. In the related art, whether in the transparency mode or the active noise reduction mode, the headphone typically sets fixed filter parameters, and processes an external sound signal according to the fixed filter parameters. However, for different external environments, a user usually has different audio listening effect requirements, so once the filter parameters are fixed, a real audio listening effect after the user wears the headphones may not match the user's desired audio listening effect, leading to a poor auditory effect.

### SUMMARY

It is advantageous to provide a headphone control method that can improve an auditory effect after wearing a headphone.

In a first aspect, the present disclosure provides a headphone control method applied to a headphone including a feed-forward microphone and a feed-back microphone. The method comprises acquiring a first audio signal by a feed-forward microphone and acquiring a second audio signal by a feed-back microphone; and determining a scene type of a scene where the headphone is located based on the first audio signal. The method further comprises obtaining a target effect audio signal based on the scene type; and determining current spectrum relationship information between the first audio signal and the second audio signal, and target spectrum relationship information between the first audio signal and the target effect audio signal. The method also comprises adjusting filter parameters of the headphone according to the current spectrum relationship information and the target spectrum relationship information; re-acquiring the second audio signal according to the adjusted filter parameters; and determining that an error between the re-acquired second audio signal and the target effect audio signal is greater than or equal to a preset error (e.g., a threshold), and returning to execute the step of acquiring the first audio signal through the feed-forward microphone and acquiring the second audio signal through the feed-back microphone, until the error between the re-acquired second audio signal and the target effect audio signal is less than the preset error.

In a second aspect, the present disclosure provides a headphone control device applied to a headphone including a feed-forward microphone and a feed-back microphone. The headphone control device includes: a signal acquisition module configured to acquire a first audio signal through the feed-forward microphone and acquire a second audio signal through the feed-back microphone; a signal obtaining module configured to determine a current scene type of an external scene where the headphone is located based on the first audio signal and obtain a target effect audio signal corresponding to the current scene type; a spectrum relationship information determination module configured to determine current spectrum relationship information between the first audio signal and the second audio signal, and target spectrum relationship information between the first audio signal and the target effect audio signal; a parameter adjustment module configured to adjust filter parameters of the headphone according to the current spectrum relationship information and the target spectrum relationship information; the signal acquisition module further configured to re-acquire the second audio signal according to the adjusted filter parameters; and an iterative circulation module configured to determine that an error between the re-acquired second audio signal and the target effect audio signal is greater than or equal to a preset error, and return to execute the step of acquiring the first audio signal through the feed-forward microphone and acquiring the second audio signal through the feed-back microphone, until the error between the re-acquired second audio signal and the target effect audio signal is less than the preset error.

In a third aspect, the present disclosure provides a headphone including a feed-forward microphone, a feed-back microphone, a processor, and a memory storing a computer program, in which the processor implements the following steps when executing the computer program: acquiring a first audio signal through the feed-forward microphone and acquiring a second audio signal through the feed-back microphone; determining a current scene type of an external scene where the headphone is located based on the first audio signal, and obtaining a target effect audio signal corresponding to the current scene type; determining current spectrum relationship information between the first audio signal and the second audio signal, and target spectrum relationship information between the first audio signal and the target effect audio signal; adjusting filter parameters of the headphone according to the current spectrum relationship information and the target spectrum relationship information; re-acquiring the second audio signal according to the adjusted filter parameters; and determining that an error between the re-acquired second audio signal and the target effect audio signal is greater than or equal to a preset error, and returning to execute the step of acquiring the first audio signal through the feed-forward microphone and acquiring the second audio signal through the feed-back microphone, until the error between the re-acquired second audio signal and the target effect audio signal is less than the preset error.

In a fourth aspect, the present disclosure provides a non-transitory computer-readable storage medium on which a computer program is stored, and the computer program implements the following steps when executed by the processor: acquiring a first audio signal through the feed-forward microphone and acquiring a second audio signal through the feed-back microphone; determining a current scene type of an external scene where the headphone is located based on the first audio signal, and obtaining a target effect audio signal corresponding to the current scene type; determining current spectrum relationship information between the first audio signal and the second audio signal, and target spectrum relationship information between the first audio signal and the target effect audio signal; adjusting filter parameters of the headphone according to the current spectrum relationship information and the target spectrum relationship information; re-acquiring the second audio signal according to the adjusted filter parameters; and determining that an error between the re-acquired second audio signal and the target effect audio signal is greater than or equal to a preset error, and returning to execute the step of acquiring the first audio signal through the feed-forward microphone and acquiring the second audio signal through the feed-back microphone, until the error between the re-acquired second audio signal and the target effect audio signal is less than the preset error.

In a fifth aspect, the present disclosure provides a computer program product including a computer program, and the computer program implements the following steps when executed by the processor: acquiring a first audio signal through the feed-forward microphone and acquiring a second audio signal through the feed-back microphone; determining a current scene type of an external scene where the headphone is located based on the first audio signal, and obtaining a target effect audio signal corresponding to the current scene type; determining current spectrum relationship information between the first audio signal and the second audio signal, and target spectrum relationship information between the first audio signal and the target effect audio signal; adjusting filter parameters of the headphone according to the current spectrum relationship information and the target spectrum relationship information; re-acquiring the second audio signal according to the adjusted filter parameters; and determining that an error between the re-acquired second audio signal and the target effect audio signal is greater than or equal to a preset error, and returning to execute the step of acquiring the first audio signal through the feed-forward microphone and acquiring the second audio signal through the feed-back microphone, until the error between the re-acquired second audio signal and the target effect audio signal is less than the preset error.

In the above headphone control method and headphone, after acquiring the first audio signal through the feed-forward microphone and acquiring the second audio signal through the feed-back microphone, the current scene type of the external scene where the headphone is located may be determined based on the first audio signal, and the target effect audio signal corresponding to the current scene type may be obtained. The current spectrum relationship information characterizing the spectrum relationship between the first audio signal and the second audio signal may be determined, and the target spectrum relationship information characterizing the spectrum relationship between the first audio signal and the target effect audio signal may be determined. By continuously (e.g., iteratively) adjusting the filter parameters of the headphone according to the current spectrum relationship information and the target spectrum relationship information, the second audio signal acquired by the feed-back microphone may gradually approach the target effect audio signal, until the signal error between the second audio signal acquired by the feed-back microphone and the target effect audio signal is less than the preset error. At this time, the sound signal heard by the user is basically consistent with the target effect audio signal (e.g., substantially similar to the target effect audio signal). Since the target effect audio signal corresponds to the current scene type of the external scene where the headphone is located, the auditory effect of the target effect audio signal matches the external environment where the headphone is located. Therefore, the auditory effect experienced by the user wearing the headphone can always approach the sound effect of the target effect audio signal and match the external environment in which the headphone is located, thereby stabilizing the headphone listening effect at a relatively high level.

### BRIEF DESCRIPTION OF THE DRAWINGS

In order to more clearly illustrate technical solutions in examples of the disclosure or in the related art, the drawings that need to be used in description of the examples or the related art are briefly introduced below, and it is apparent that the accompanying drawings described below are merely some examples of the present disclosure, and for those of ordinary skill in the art, other drawings can be obtained based on these drawings without inventive work.

FIG. 1 is a schematic flowchart of a headphone control method in an example of the present disclosure;

FIG. 2 is a schematic flowchart of adjusting filter parameters of a headphone in an example of the present disclosure;

FIG. 3 is a structural block diagram of a headphone control device in an example of the present disclosure; and

FIG. 4 is an internal structure diagram of a headphone in an example of the present disclosure.

### DETAILED DESCRIPTION

In order to make the object, technical solutions, and advantages of the present disclosure clearer and easier to understand, further detailed description of the present disclosure is made with reference to accompanying drawings and examples below. It can be understood that the specific examples described herein are merely for explaining the present disclosure and are not for limiting the present disclosure.

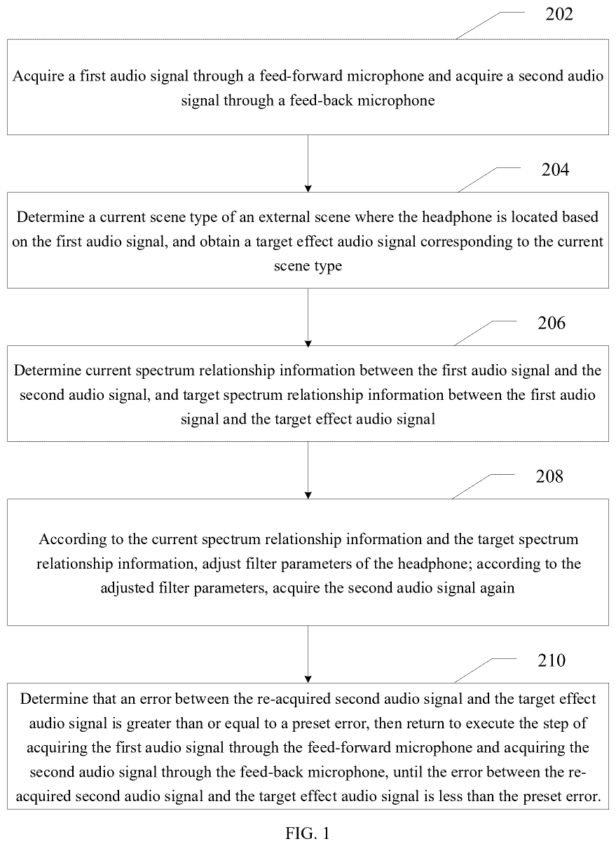

In an example, as shown in FIG. 1, a headphone control method is provided. The example describes application of the method to headphones as an example. A pair of headphones can include a feed-forward microphone and a feed-back microphone. It can be understood that, in the present example, the form of the headphones is not limited, and the headphone may be a wireless Bluetooth headphone, a head-mounted headphone, or the like. In the present example, the method includes the following steps 202 to 210. The method may be performed by headphones. For example, the headphones may include a controller that is configured to perform some or all of the steps 202 to 210. Some of the steps may be performed by, for examples, one or more microphones of the headphones.

Step 202: acquiring a first audio signal through a feed-forward microphone and acquiring a second audio signal through a feed-back microphone.

Headphones can have a transparency mode and a noise reduction mode. In the transparency mode, headphones may transmit an external sound signal to a user; while in the noise reduction mode, headphone may shield the external sound signal as noise from the user. A headphone can be provided with a feed-forward microphone (e.g., a reference microphone) and a feed-back microphone (e.g., an error microphone). The feed-forward microphone is usually disposed in an area on the headphone that is in contact with the external space, and is configured to acquire the external sound signal. The feed-back microphone is usually disposed in an area on the headphone toward a side of the user's ear canal, and is configured to acquire an audio signal transmitted into the user's ear canal. The audio signal acquired by the feed-back microphone may be taken as a real audio signal actually heard by the user.

For example, the first audio signal may be an external sound signal acquired by the feed-forward microphone, and the second audio signal may be the sound signal transmitted to the feed-back microphone and acquired by the feed-back microphone.

Step 204: determining, based on the first audio signal, a current scene type of an external scene where the headphone is located, and obtaining a target effect audio signal corresponding to the current scene type.

Specifically, a user usually has different auditory effect requirements in different external scenes (e.g., environments). For example, in an airport scene, the user usually wishes to filter out noise of taking off and landing of an aircraft but retain speaking sound of other people. In a sleep scene, the user usually wishes to shield snoring sound of other people but retain alarm clock sound and speaking sound.

In the present example, effect audio signals in multiple types of external scenes may be set to match a corresponding external scene type, and may bring a better auditory effect to the user in the corresponding type of external scene.

As an example, step 204 includes: extracting an audio signal feature from the first audio signal, classifying the audio signal feature to obtain a feature classification result, and determining the current scene type of the external scene where the headphone is located according to the feature classification result. The audio signal feature at least characterizes one of an amplitude feature and a frequency feature of the first audio signal.

In an example, determining, based on the first audio signal, the current scene type of the external scene where the headphone is located includes: extracting an audio signal feature from the first audio signal; and determining the current scene type of the external scene where the headphone is located according to the audio signal feature.

Specifically, step 204 includes converting the first audio signal from a time domain to a frequency domain to obtain a first spectrum signal corresponding to the first audio signal; and detecting the current scene type of the external scene where the headphone is located according to spectrum signal features of the first spectrum signal in various preset frequency bands.

In addition, in the present example, a step may also be triggered when it is detected that the external scene where the headphone is located has changed. For example, the method may include detecting the current scene type of the external scene where the headphone is located according to the first audio signal to obtain a scene type identifier; and using the scene type identifier as an index to find the target effect audio signal corresponding to the scene type identifier.

In some examples, when detecting that the external scene where the headphone is located has changed, the current scene type of the external scene where the headphone is located may also be detected according to the first audio signal to obtain a scene type identifier. The scene type identifier may be pushed to a terminal device corresponding to the headphone, and the terminal device is used for displaying multiple corresponding effect audio signals according to the scene type identifier. The corresponding effect audio signals may be all audio signals with better auditory effect in the scene corresponding to the scene type identifier. The terminal device can respond to a selection operation of the user, select the target effect audio signal from the multiple corresponding effect audio signals, and push the target effect audio signal to the headphone. The headphone receives the target effect audio signal fed back by the terminal device. The selection operation may be a click operation, a text input operation, or a box selection operation, etc.

As an example, the headphone includes a motion detection module, and detecting whether the external scene where the headphone is located has changed includes: detecting, by the motion detection module on the headphone, a displacement distance of the headphone in the external environment. If the displacement distance is greater than a preset distance threshold, the external scene where the headphone is located is determined to have changed. If the displacement distance is less than or equal to the preset distance threshold, the external scene where the headphone is located is determined to have not changed.

It should be noted that, the target effect audio signal may be an audio signal characterizing a transparency effect of the headphone, may also be an audio signal characterizing an active noise reduction effect of the headphone, and may also be an audio signal characterizing the transparency effect and the active noise reduction effect of the headphone, so the target effect audio signal at least includes one of the following:
a. an active noise reduction effect audio signal of a full frequency band;
b. a transparency effect audio signal of a full frequency band; and
c. active noise reduction effect audio signals of multiple first frequency bands and transparency effect audio signals of multiple second frequency bands, in which the multiple first frequency bands and the multiple second frequency bands form the full frequency band.

Step 206: determining current spectrum relationship information between the first audio signal and the second audio signal, and target spectrum relationship information between the first audio signal and the target effect audio signal.

For example, the target effect audio signal is an audio signal having an expected auditory effect matching the external environment. If a spectrogram of the second audio signal transmitted to the feed-back microphone from the external sound signal and a spectrogram of the target effect audio signal approach consistency, the headphone is determined to currently have the expected auditory effect, and the auditory effect of the user wearing the headphone in the current external scene is better.

As an example, step 206 includes: converting the first audio signal from the time domain to the frequency domain to obtain a first spectrum signal corresponding to the first audio signal, and converting the second audio signal from the time domain to the frequency domain to obtain a second spectrum signal corresponding to the second audio signal; determining the current spectrum relationship information between the first spectrum signal and the second spectrum signal, in which the current spectrum relationship information is used for characterizing a spectrum relationship between the first audio signal and the second audio signal; and determining the target spectrum relationship information between the first spectrum signal corresponding to the first audio signal and a third spectrum signal corresponding to the target effect audio signal, in which the target spectrum relationship information is used for characterizing a spectrum relationship between the first audio signal and the target effect audio signal.

As an example, determining the current spectrum relationship information between the first spectrum signal and the second spectrum signal includes: calculating a signal ratio between the second spectrum signal and the first spectrum signal to obtain the current spectrum relationship information.

For example, a first sampling value of the first spectrum signal at each preset frequency and a second sampling value of the second spectrum signal at each preset frequency may be obtained. A ratio between the second sampling value and the first sampling value at each preset frequency is calculated to obtain a first sampling value ratio at each preset frequency. The first sampling value ratio at each preset frequency is used as the current spectrum relationship information.

As an example, determining the target spectrum relationship information between the first spectrum signal corresponding to the first audio signal and the third spectrum signal corresponding to the target effect audio signal includes: calculating a signal ratio between the third spectrum signal and the first spectrum signal to obtain the target spectrum relationship information.

For example, a first sampling value of the first spectrum signal at each preset frequency and a third sampling value of the third spectrum signal at each preset frequency are obtained; a ratio between the third sampling value and the first sampling value at each preset frequency is calculated, to obtain a second sampling value ratio at each preset frequency; and the second sampling value ratio at each preset frequency is used as the target spectrum relationship information.

Step 208: adjusting filter parameters of the headphone according to the current spectrum relationship information and the target spectrum relationship information; and re-acquiring the second audio signal according to the adjusted filter parameters.

For example, the filter parameter may include a gain at each preset frequency, and a sound signal amplitude at the preset frequency may be adjusted according to the gain at the preset frequency.

If the filter parameters of the headphone change, the sound signal transmitted from the external sound signal into the ear canal may also change accordingly, so the second audio signal acquired by the feed-back microphone may also change accordingly.

The re-acquiring the second audio signal according to the adjusted filter parameters may include acquiring another audio signal using the adjusted filter parameters by the feed-back microphone on the headphone. The another audio signal may be substantial similar to the second audio signal because it is acquired soon after the second audio signal is acquired. Additionally or alternatively, the re-acquiring the second audio signal according to the adjusted filter parameters may include filtering the acquired second audio signal using the adjusted filter parameters.

As an example, step 208 includes: calculating a difference between the current spectrum relationship information and the target spectrum relationship information to obtain spectrum deviation information; and adjusting the filter parameters of the headphone according to the spectrum deviation information.

Step 210: determining that an error between the re-acquired second audio signal and the target effect audio signal is greater than or equal to a preset error, then returning to execute the step of acquiring the first audio signal through the feed-forward microphone and acquiring the second audio signal through the feed-back microphone, until the error between the re-acquired second audio signal and the target effect audio signal is less than the preset error. The error may be a measurable deviation between the second audio signal and the target effect audio signal.

For example, a signal error between the second audio signal and the target effect audio signal may be a spectrum signal error between the second spectrum signal corresponding to the second audio signal and the third spectrum signal corresponding to the target effect audio signal. As an example, step 210 includes: determining that the signal error between the second audio signal re-acquired by the feed-back microphone and the target effect audio signal is greater than or equal to the preset error, then re-executing the step of acquiring the first audio signal through the feed-forward microphone and acquiring the second audio signal through the feed-back microphone, so as to re-determine the current spectrum relationship information and the target spectrum relationship signal, until the error between the second audio signal re-acquired by the feed-back microphone and the target effect audio signal is less than the preset error.

Determining that the signal error between the second audio signal re-acquired by the feed-back microphone and the target effect audio signal is less than the preset error may indicate that the filter parameter adjustment of the headphone is finished, and the adjusted filter parameters already meet requirements.

As an example, the current spectrum relationship information includes the first sampling value ratios at various preset frequencies, and the target spectrum relationship information includes the second sampling value ratios at various preset frequencies. The above calculating the difference between the current spectrum relationship information and the target spectrum relationship information to obtain the spectrum deviation information; and adjusting the filter parameters of the headphone according to the spectrum deviation information may include: calculating differences between the first sampling value ratios and the second sampling value ratios at the preset frequencies respectively to obtain ratio differences at the preset frequencies jointly as the spectrum deviation information; finding parameter adjustment information corresponding to the ratio differences at the preset frequencies according to a mapping relationship between the ratio difference and parameter adjustment information; and adjusting the filter parameters of the headphone at the preset frequencies respectively according to the parameter adjustment information at the preset frequencies.

The mapping relationship between the ratio difference and the parameter adjustment information in the present example may be a fixed mapping relationship. Because different users have different ear canal structures and headphone wearing states, after adjusting the filter parameters of the headphone for the first time, the auditory effect of the headphone usually cannot be directly adjusted to be consistent with the auditory effect of the target effect audio signal. But in the present example, spectrum deviation information may be continuously determined based on the first audio signal acquired by the feed-forward microphone and the second audio signal acquired by the feed-back microphone, and the headphone filter parameters are iteratively adjusted using the spectrum deviation information. During the process of continuously adjusting the filter parameters of the headphone, the second audio signal acquired by the feed-back microphone may gradually approach the target effect audio signal, and finally achieve the expected headphone auditory effect, that is, the auditory effect of the headphone approaches the sound effect of the target effect audio signal Therefore, even when differences exist in ear canal structures and headphone wearing states among different users, in the present example, the second audio signal acquired by the feed-back microphone can always be adjusted to approach the target effect audio signal. The auditory effect of the headphone is adjusted to match the external environment where the headphone is located, and thus the auditory effect after wearing the headphone may be improved.

In the above headphone control method, after acquiring the first audio signal through the feed-forward microphone and acquiring the second audio signal through the feed-back microphone, the current scene type of the external scene where the headphone is located is first determined based on the first audio signal, and the target effect audio signal corresponding to the current scene type is obtained, then the current spectrum relationship information characterizing the spectrum relationship between the first audio signal and the second audio signal is determined, and the target spectrum relationship information characterizing the spectrum relationship between the first audio signal and the target effect audio signal is determined. In this way, by continuously adjusting the filter parameters of the headphone according to the current spectrum relationship information and the target spectrum relationship information, the second audio signal acquired by the feed-back microphone may gradually approach the target effect audio signal, until the signal error between the second audio signal acquired by the feed-back microphone and the target effect audio signal is less than the preset error, and at this time, the sound signal heard by the user is basically consistent with the target effect audio signal. Since the target effect audio signal corresponds to the current scene type of the external scene where the headphone is located, the auditory effect of the target effect audio signal matches the external environment where the headphone is located. At this time, the auditory effect after the user wears the headphone can always tends to be consistent with the sound effect of the target effect audio signal, matching the external environment where the headphone is located. Thus, the auditory effect of the headphone may be stabilized at a better level, so the auditory effect after wearing the headphone may be improved.

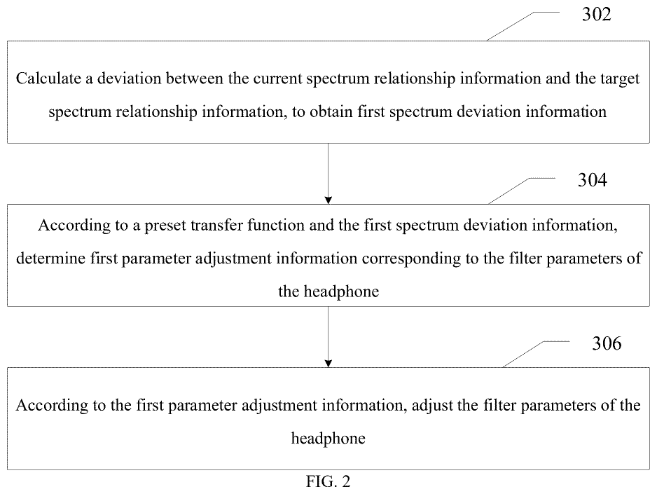

In an example, as shown in FIG. 2, adjusting the filter parameters of the headphone according to the current spectrum relationship information and the target spectrum relationship information includes step 302 to step 306.

Step 302: calculating a deviation between the current spectrum relationship information and the target spectrum relationship information to obtain first spectrum deviation information.

For example, the current spectrum relationship information may be the first sampling value ratio between the second sampling value and the first sampling value at each preset frequency, and the target spectrum relationship information may be the second sampling value ratio between the third sampling value and the first sampling value at each preset frequency, in which, the first sampling value is a sampling value at the preset frequency in the first spectrum signal corresponding to the first audio signal, the second sampling value is a sampling value at the preset frequency in the second spectrum signal corresponding to the second audio signal, and the third sampling value is a sampling value at the preset frequency in the third spectrum signal corresponding to the target effect audio signal.

As an example, step 302 includes: calculating a difference between the first sampling value ratio and the second sampling value ratio at each preset frequency to obtain a ratio difference at each preset frequency as the first spectrum deviation information.

Step 304: determining first parameter adjustment information corresponding to the filter parameters of the headphone according to a preset transfer function and the first spectrum deviation information.

For example, the preset transfer function may be a preset transfer function of sound played by a speaker of the headphone to the feed-back microphone, the preset transfer function is affected by the user's ear canal structure and headphone wearing state, and the headphone wearing state may be a wearing tightness of the headphone.

As an example, step 304 includes: calculating the first parameter adjustment information corresponding to the filter parameters of the headphone according to the preset transfer function and the first spectrum deviation information.

In an example, the first parameter adjustment information includes a parameter adjustment amplitude and a parameter adjustment direction; determining the first parameter adjustment information corresponding to the filter parameters of the headphone according to the preset transfer function and the first spectrum deviation information includes: determining, according to the first spectrum deviation information, a signal amplitude deviation between the first audio signal and the second audio signal in each preset frequency band; and determining, according to the signal amplitude deviation in each preset frequency band and the preset transfer function, the parameter adjustment amplitude and the parameter adjustment direction of the filter parameters of the headphone in each preset frequency band.

For example, obtaining a deviation value at each preset frequency in the first spectrum deviation information, in which the deviation value is a ratio difference between the first sampling value ratio and the second sampling value ratio at the preset frequency; averaging the deviation value corresponding to the preset frequency in each preset frequency band to obtain the signal amplitude deviation between the first spectrum signal corresponding to the first audio signal and the second spectrum signal corresponding to the second audio signal in each preset frequency band; and calculating, according to the signal amplitude deviation in each preset frequency band and the preset transfer function, the parameter adjustment amplitude and the parameter adjustment direction of the filter parameters of the headphone in each preset frequency band, in which the parameter adjustment amplitude may be an absolute value of the first parameter adjustment information, and the parameter adjustment direction is in positive and negative correlation with the first parameter adjustment information. For example, the value of the first parameter adjustment information may be set to be positive, then the parameter adjustment direction is a decreasing direction, and when the value of the first parameter adjustment information is negative, the parameter adjustment direction is an increasing direction.

As an example, a specific formula for calculating the first parameter adjustment information corresponding to the filter parameters of the headphone is as follows:

$$( {W}_{k} - {W}_{opt} ) * SP = \frac{( {H}_{real} - {H}_{target} )}{FF} \qquad ( 1 )$$

wherein wₖ-wₒₚₜ is the first parameter adjustment information, wₖ is the filter parameters before adjustment, wₒₚₜ is the filter parameters after adjustment, SP is the preset transfer function, Hᵣₑₐₗ is the sound signal acquired by the feed-back microphone after the external sound signal is transmitted to the feed-back microphone, that is, the second audio signal, H_{target} is the target effect audio signal, FF is the external sound signal acquired by the feed-forward microphone, that is, the first audio signal,

$$\frac{{H}_{real}}{FF}$$

is the current spectrum relationship information,

$$\frac{{H}_{target}}{FF}$$

is the target spectrum relationship information, and

$$\frac{{H}_{real} - {H}_{target}}{FF}$$

is the deviation between the current spectrum relationship information and the target spectrum relationship information.

As may be seen from formula (1), in the present example, the preset transfer function is set to a fixed value, but because the ear canal structure and the headphone wearing state of each user both have differences, so a difference still exists between the preset transfer function and the real transfer function of the sound played by the speaker of the headphone to the feed-back microphone, but in the above formula (1), the filter parameters are iteratively adjusted constantly based on the difference of Hᵣₑₐₗ−H_{target}, so in the iterative adjustment process, Hᵣₑₐₗ may constantly approach H_{target}, finally may approach consistency with H_{target}, at this time the auditory effect perceived by the user always approaches consistency with the auditory effect of the target effect audio signal, so in the present example the adjustment process of the auditory effect of the headphone is not affected by the ear canal structure of the user and the headphone wearing state, the auditory effect of the headphone is finally always stabilized at a better level, always matching the external environment where the headphone is located, thus.

As an example, a derivation process of the above formula (1) is as follows:

$$\begin{matrix}FF * {w}_{opt} * SP + {FB}^{′} - SPK * SP = {H}_{target} \\ ⇒ {w}_{opt} * SP + \frac{{FB}^{′} - SPK * SP}{FF} = \frac{{H}_{target}}{FF}\end{matrix} \qquad ( 2 )$$

$$\begin{matrix}FF * {w}_{k} * SP + {FB}^{′} - SPK * SP = {H}_{real} \\ ⇒ {w}_{opt} * SP + \frac{{FB}^{′} - SPK * SP}{FF} = \frac{{H}_{real}}{FF}\end{matrix} \qquad ( 3 )$$

The formula (1) is obtained by subtracting formula (2) from formula (3), wherein wₖ is the filter parameters before adjustment, wₒₚₜ is the filter parameters after adjustment, SP is the preset transfer function, Hᵣₑₐₗ is the sound signal acquired by the feed-back microphone after the external sound signal is transmitted to the feed-back microphone, that is, the second audio signal, H_{target} is the target effect audio signal, FF is the external sound signal acquired by the feed-forward microphone, that is, the first audio signal, SPK is the audio signal inherent to the headphone played by the speaker, for example, music or a call audio signal played by the headphone, FB′ is the sound signal picked up by the feed-back microphone after the external sound signal is directly transmitted to the feed-back microphone without passing through the speaker. Under normal circumstances, the external sound signal may be acquired by the feed-forward microphone to obtain the first audio signal (FF), then the first audio signal may be played by the speaker after being filtered, and then transmitted to the feed-back microphone, but the headphone cannot be completely sound-insulating due to material limitations, and thus there will be part of the external sound signal directly transmitted to the feed-back microphone through the headphone, and picked up by the feed-back microphone to form FB′.

Step 306: adjusting the filter parameters of the headphone according to the first parameter adjustment information.

Specifically, the filter parameters of the headphone may include filter parameters in various preset frequency bands, the filter parameters in the various preset frequency bands are used for respectively filtering the external sound signals in the various preset frequency bands; the first parameter adjustment information may include the parameter adjustment direction and the parameter adjustment amplitude corresponding to various preset frequency bands.

As an example, step 306 includes: adjusting the filter parameters in each preset frequency band according to the parameter adjustment direction and the parameter adjustment amplitude corresponding to each preset frequency band.

In the example, the ear canal structure and the headphone wearing state of each user both have differences, so a difference still exists between the preset transfer function and the real transfer function of the sound played by the speaker of the headphone to the feed-back microphone, therefore setting the preset transfer function to a fixed value, although not being able to adjust the auditory effect of the headphone to approach consistency with the auditory effect of the target effect audio signal at one time, because the filter parameters of the headphone are iteratively adjusted constantly based on the deviation between the current spectrum relationship information and the target spectrum relationship information, in the iterative process, the current spectrum relationship information may constantly approach the target spectrum relationship information, and finally approach consistency, at which time the auditory effect perceived by the user always approaches consistency with the auditory effect of the target effect audio signal, so in the example, the adjustment process of the auditory effect of the headphone is not affected by the ear canal structure of the user and the headphone wearing state, thus improving the auditory effect after wearing the headphone.

In an example, the headphone is provided with multiple feed-forward microphones corresponding to multiple sound transmission directions, the first audio signal includes external sound signals in the multiple sound transmission directions, the current spectrum relationship information includes first spectrum relationship information corresponding to the external sound signals in the multiple sound transmission directions, and the target spectrum relationship information includes second spectrum relationship information corresponding to the external sound signals in the multiple sound transmission directions; and adjusting the filter parameters of the headphone according to the current spectrum relationship information and the target spectrum relationship information includes: calculating a deviation between the first spectrum relationship information and the second spectrum relationship information in each of the sound transmission directions to obtain second spectrum deviation information in each of the sound transmission directions; determining second parameter adjustment information corresponding to the filter parameters of the headphone in each of the sound transmission directions according to the second spectrum deviation information in each of the sound transmission directions; and adjusting the filter parameters of the headphone in each of the sound transmission directions according to the second parameter adjustment information.

Specifically, multiple feed-forward microphones may be disposed on the headphone, the feed-forward microphones may be used for acquiring the external sound signals in different sound transmission directions, for example, a left-right direction or a front-rear direction; the first spectrum relationship information may be a first sampling value ratio between the second sampling value and the first sampling value at each preset frequency in one sound transmission direction, and the second spectrum relationship information may be a second sampling value ratio between the third sampling value and the first sampling value at each preset frequency in one sound transmission direction.

Specifically, for the first spectrum relationship information and the second spectrum relationship information in each sound transmission direction, calculating a difference between the first sampling value ratio and the second sampling value ratio at each preset frequency to obtain a ratio difference at each preset frequency as the second spectrum deviation information; calculating the second parameter adjustment information corresponding to the filter parameters of the headphone in each sound transmission direction according to the preset transfer function and the second spectrum deviation information in each sound transmission direction; and for each sound transmission direction, adjusting the filter parameters of the headphone in the sound transmission direction according to the second parameter adjustment information.

As an example, the specific calculation process of the second parameter adjustment information may refer to the specific calculation process of the first parameter adjustment information, which will not be repeated here.

As an example, the filter parameters of the headphone in the sound transmission direction are adjusted according to the parameter adjustment direction and the parameter adjustment amplitude in the second parameter adjustment information.

In an example, the headphone control method further includes: adjusting a signal amplitude of the target effect audio signal in response to a first adjustment instruction.

Specifically, the first adjustment instruction may be determined by a user performing a touch or click operation on the headphone body, or may be determined by a user performing an operation on a terminal device connected to the headphone, and the first adjustment instruction is used for adjusting an overall signal amplitude of the target effect audio signal, that is, turning down or turning up the signal amplitude of the target effect audio signal in the preset frequency bands overall.

In an example, the headphone control method further includes: adjusting a signal amplitude distribution of the target effect audio signal in each of the preset frequency bands in response to a second adjustment instruction.

Specifically, the second adjustment instruction may be determined by a user performing a touch or click operation on the headphone body, or may be determined by a user performing an operation on a terminal device connected to the headphone, the second adjustment instruction is used for adjusting a frequency response feature of the target effect audio signal in various preset frequency bands, so that the target effect audio signal meets user expectations better, for example, the frequency response feature of a preset frequency band corresponding to human voice may be selected to be separately adjusted, thereby achieving human voice enhancement, in which, the frequency response feature may characterize a relationship between the amplitude and phase of a sound signal and frequency.

In an example, the headphone control method further includes: adjusting a signal amplitude of the target effect audio signal in a target transmission direction in response to a third adjustment instruction.

Specifically, the third adjustment instruction may be determined by a user performing a touch or click operation on the headphone body, or may be determined by a user performing an operation on a terminal device connected to the headphone, the third adjustment instruction is used for adjusting a signal strength of the target effect audio signal in the target transmission direction of the headphone, thereby achieving separate adjustment of the target effect audio signal in the target transmission direction, and thus separately adjusting the auditory effect of the headphone in a single sound transmission direction.

In an example, the headphone control method further includes: adjusting a signal amplitude distribution of the target effect audio signal in the preset frequency bands in the target transmission direction in response to a fourth adjustment instruction.

Specifically, the fourth adjustment instruction may be determined by a user performing a touch or click operation on the headphone body, or may be determined by a user performing an operation on a terminal device connected to the headphone, the fourth adjustment instruction is used for adjusting a frequency response feature of the target effect audio signal in various preset frequency bands in the target transmission direction of the headphone, so that the target effect audio signal in the target transmission direction of the headphone meets user expectations better, for example, the frequency response feature of a preset frequency band corresponding to human voice may be selected to be separately adjusted in the target transmission direction, thereby achieving human voice enhancement separately in one sound transmission direction, in which the frequency response feature may characterize the relationship between the amplitude as well as phase and the frequency of the sound signal.

In an example, the headphone control method may further include: detecting a wearing state of the headphone in real time; and if the wearing state of the headphone has changed, triggering execution of the step of determining current spectrum relationship information between the first audio signal and the second audio signal, and target spectrum relationship information between the first audio signal and the target effect audio signal.

In an example, the wearing state may be a wearing position or a wearing tightness of the headphone. The wearing state of the headphone may be detected in real time. If the wearing state changes, it indicates that the auditory effect of the headphone at this time may be affected, and thus real-time detection of the wearing state of the headphone is triggered. If the wearing state of the headphone changes, the step of determining the current spectrum relationship information between the first audio signal and the second audio signal, and the target spectrum relationship information between the first audio signal and the target effect audio signal is triggered to adjust the auditory effect of the headphone, so that the auditory effect of the headphone is stabilized at a better level. In this way, even if the auditory effect of the headphone is affected by the change of the wearing state, the headphone may also automatically adjust triggering execution of spectrum information determination, thereby automatically adjusting the auditory effect of the headphone to optimal.

It should be noted that, in the example, the headphone may be configured to detect the current scene type of the external scene where the headphone is located in real time, for example, the scene type of the external scene where the headphone is located may be detected according to at least one of a time domain signal feature and a frequency domain signal feature of the first audio signal. In the process of detecting the scene type of the external scene where the headphone is located according to at least one of the time domain signal feature and the frequency domain signal feature of the first audio signal, an AI model usually needs to be used. AI models require higher computing power, which may lead to excessive power consumption of the headphone, and therefore, it may be first detected whether the scene type of the external scene where the headphone is located has changed, and only when the scene type of the external scene where the headphone is located changes, is the detection of the scene type of the external scene where the headphone is located triggered based on at least one of the time domain signal feature and the frequency domain signal feature of the first audio signal.

In an example, the above headphone control method may further include: obtaining a scene type detected by the headphone previously, and determining a target detection frequency band according to the previously detected scene type. If a signal amplitude change value of the first audio signal in the target detection frequency band is greater than a preset change threshold, determining that the scene type of the external scene where the headphone is located has changed, and executing the step of determining the current scene type of the external scene where the headphone is located based on the first audio signal. If the signal amplitude change value of the first audio signal in the target detection frequency band is not greater than the preset change threshold, determining that the scene type of the external scene where the headphone is located has not changed, and determining the previously detected scene type as the current scene type of the external scene where the headphone is located.

In an example, target effect audio features of different scene types usually have specific sound signal distribution features in some specific frequency bands, for example, the sound amplitude may conform to a specific sound amplitude magnitude distribution in some specific frequency bands.

In an example, obtaining a previous scene type identifier of the scene type detected by the headphone previously, and finding the target detection frequency band with the previous scene type identifier. If the signal amplitude change value of the first audio signal acquired by the feed-forward microphone in the target detection frequency band is greater than the preset change threshold, the scene type of the external scene where the headphone is located may be determined to have changed, thereby triggering execution of the above step of determining the current scene type of the external scene where the headphone is located based on the first audio signal. If the signal amplitude change value of the first audio signal acquired by the feed-forward microphone in the target detection frequency band is not greater than the preset change threshold, the scene type of the external scene where the headphone is located may be determined to have not changed, thereby the previously detected scene type may be directly determined as the current scene type of the external scene where the headphone is located. In this way, the target detection frequency band of the previously detected scene type is realized, and then by monitoring the sound amplitude change of the first audio signal in the target detection frequency band, whether the scene type of the external scene where the headphone is located has changed may be indirectly detected, to decide whether to use the currently acquired first audio signal to check the current scene type. The entire detection process does not need to re-detect the scene type of the external scene every time, but only after detecting that the scene type of the external scene where the headphone is located has changed, the detection process of the scene type of the external scene where the headphone is located is triggered, but the detection process of the scene type of the external scene where the headphone is located is not performed in real time, thus reducing the power consumption of the headphone.

It should be understood that, although the various steps in the flowcharts involved in the examples described above are displayed in the order indicated by the arrows, these steps are not necessarily performed in the order indicated by the arrows. Unless explicitly stated herein, there is no strict sequential restriction on the execution of these steps, and they may be performed in other orders. Furthermore, at least part of the steps in the flowcharts involved in the examples described above may include multiple steps or multiple stages, and these steps or stages are not necessarily completed at the same time but may be executed at different times. The execution order of these steps or stages is also not necessarily sequential but may be performed in turn or alternately with at least part of other steps, or at least part of steps or stages in other steps.

Based on the same inventive concept, an example of the disclosure further provides a headphone control device configured to implement the headphone control method involved above. The implementation solution provided by the device for solving the problem is similar to the implementation solution described in the foregoing method. Therefore, the specific limitations of one or more examples of the headphone control device to be provided below may refer to the above limitations of the headphone control method, and will not be repeated here.

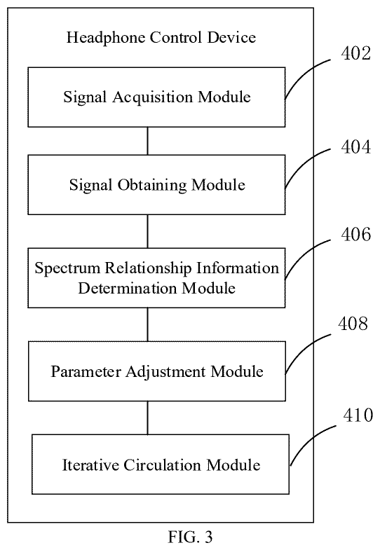

In an example, as shown in FIG. 3, a headphone control device is provided, including: a signal acquisition module 402, a signal obtaining module 404, a spectrum relationship information determination module 406, a parameter adjustment module 408, and an iterative circulation module 410.

The signal acquisition module 402 is configured to acquire a first audio signal through the feed-forward microphone and acquire a second audio signal through the feed-back microphone.

The signal obtaining module 404 is configured to determine a current scene type of an external scene where the headphone is located based on the first audio signal and obtain a target effect audio signal corresponding to the current scene type.

The spectrum relationship information determination module 406 is configured to determine current spectrum relationship information between the first audio signal and the second audio signal, and target spectrum relationship information between the first audio signal and the target effect audio signal.

The parameter adjustment module 408 is configured to adjust filter parameters of the headphone according to the current spectrum relationship information and the target spectrum relationship information.

The signal acquisition module 402 is further configured to re-acquire the second audio signal according to the adjusted filter parameters.

The iterative circulation module 410 is configured to determine that an error between the re-acquired second audio signal and the target effect audio signal is greater than or equal to a preset error, and then return to execute the step of acquiring the first audio signal through the feed-forward microphone and acquiring the second audio signal through the feed-back microphone, until the error between the re-acquired second audio signal and the target effect audio signal is less than the preset error.

In an example, the signal acquisition module is further configured to extract an audio signal feature from the first audio signal; and determine the current scene type of the external scene where the headphone is located according to the audio signal feature.

In an example, the signal acquisition module is further configured to obtain a scene type detected by the headphone previously, and determine a target detection frequency band according to the previously detected scene type; and if a signal amplitude change value of the first audio signal in the target detection frequency band is greater than a preset change threshold, determine that the scene type of the external scene where the headphone is located has changed, and execute the step of determining the current scene type of the external scene where the headphone is located based on the first audio signal; if a signal amplitude change value of the first audio signal in the target detection frequency band is not greater than a preset change threshold, determine that the scene type of the external scene where the headphone is located has not changed, and determine the previously detected scene type as the current scene type of the external scene where the headphone is located.

In an example, the parameter adjustment module is further configured to: calculate a deviation between the current spectrum relationship information and the target spectrum relationship information to obtain first spectrum deviation information; determine first parameter adjustment information corresponding to the filter parameters of the headphone according to a preset transfer function and the first spectrum deviation information; and adjust the filter parameters of the headphone according to the first parameter adjustment information.

In an example, the first parameter adjustment information includes a parameter adjustment amplitude and a parameter adjustment direction; the parameter adjustment module is further configured to: determine, according to the first spectrum deviation information, a signal amplitude deviation between the first audio signal and the second audio signal in each of preset frequency bands; and determine, according to the signal amplitude deviation in each of the preset frequency bands and the preset transfer function, the parameter adjustment amplitude and the parameter adjustment direction of the filter parameters of the headphone in each of the preset frequency bands.

In an example, the headphone control device further includes: a signal adjustment module configured to adjust a signal amplitude of the target effect audio signal in response to a first adjustment instruction; or adjust a signal amplitude distribution of the target effect audio signal in each of preset frequency bands in response to a second adjustment instruction.

In an example, the headphone control device further includes: a wearing state detection module configured to detect a wearing state of the headphone in real time; and if the wearing state of the headphone has changed, trigger execution of the step of determining current spectrum relationship information between the first audio signal and the second audio signal, and target spectrum relationship information between the first audio signal and the target effect audio signal.

In an example, the target effect audio signal at least includes one of: an active noise reduction effect audio signal of a full frequency band; a transparency effect audio signal of a full frequency band; and active noise reduction effect audio signals of multiple first frequency bands and transparency effect audio signals of multiple second frequency bands, in which the multiple first frequency bands and the multiple second frequency bands form the full frequency band.

In an example, the headphone is provided with multiple feed-forward microphones corresponding to multiple sound transmission directions, the first audio signal includes external sound signals in the multiple sound transmission directions, the current spectrum relationship information includes first spectrum relationship information corresponding to the external sound signals in the multiple sound transmission directions, and the target spectrum relationship information includes second spectrum relationship information corresponding to the external sound signals in the multiple sound transmission directions; the parameter adjustment module is further configured to: calculate a deviation between the first spectrum relationship information and the second spectrum relationship information in each of the sound transmission directions to obtain second spectrum deviation information in each of the sound transmission directions; determine second parameter adjustment information corresponding to the filter parameters of the headphone in each of the sound transmission directions according to the second spectrum deviation information in each of the sound transmission directions; and adjust the filter parameters of the headphone in each of the sound transmission directions according to the second parameter adjustment information.

All or part of the modules in the headphone control device may be implemented in software, hardware, or a combination of both. The above modules may be embedded in or independent of the processor of the headphone in a hardware form, or stored in the memory of the headphone in a software form, so that the processor can invoke and execute the operations corresponding to the above modules.

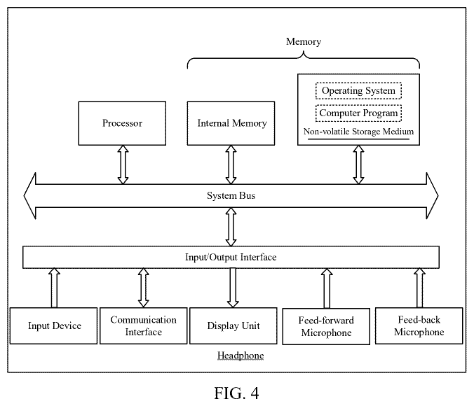

In an example, a headphone is provided, and an internal structure diagram of the headphone may be as shown in FIG. 4. The headphone includes a feed-forward microphone, a feed-back microphone, a processor, a memory, an input/output interface, a communication interface, a display unit, and an input device. The feed-forward microphone is used for acquiring an external sound signal, the feed-back microphone is used for a sound signal within an ear canal of a headphone wearer; the processor, the memory, and the input/output interface are connected through a system bus, the communication interface, the display unit, and the input device are connected to the system bus through the input/output interface. The processor of the headphone is used for providing computing and control capability. The memory of the headphone includes a non-volatile storage medium and an internal memory. The non-volatile storage medium stores an operating system and a computer program. The internal memory provides an environment for operation of the operating system and the computer program in the non-volatile storage medium. The input/output interface of the headphone is used for exchanging information between the processor and an external device. The communication interface of the headphone is used for communicating with an external terminal in a wired or wireless manner, the wireless manner may be implemented through WIFI, a mobile cellular network, near field communication (Near Field Communication, NFC), or other technology. The computer program is executed by the processor to implement a headphone control method.

It can be understood by those skilled in the art that the structure shown in FIG. 4 is merely a block diagram of part of the structure related to the solution of the present disclosure, and does not limit the headphone to which the present solution is applied. The specific headphone may include more or less components than those shown in the drawings, may combine certain components, or may have different component arrangements.

In an example, a headphone is provided, including a feed-forward microphone, a feed-back microphone, a processor, and a memory storing a computer program, in which the processor implements steps of the above method examples when executing the computer program.

In an example, a computer-readable storage medium is provided, on which a computer program is stored, and the computer program implements steps of the above method examples when executed by the processor.

In an example, a computer program product is provided, including a computer program, and the computer program implements steps of the above method examples when executed by the processor.

Those skilled in the art can understand that all or part of the processes in the above examples can be accomplished by instructing relevant hardware through a computer program. The computer program can be stored in a non-transitory non-volatile computer-readable storage medium, and may include the processes of the examples of the above methods when executed. Any reference to memory, database, or other media used in the examples provided in the present disclosure may include at least one of non-volatile and volatile memories. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache memory, and the like. As an illustration and not a limitation, the RAM may take various forms, such as a static random access memory (SRAM) or a dynamic random access memory (DRAM), and the like. The databases involved in the examples provided in the present disclosure may include at least one of relational databases and non-relational databases. Non-relational databases may include distributed databases based on blockchain, but are not limited to these. The processors involved in the examples provided in the present disclosure may be general-purpose processors, central processing units, graphics processors, digital signal processors, programmable logic units, quantum computing based data processing logic units, artificial intelligence (AI) processors and the like, but are not limited to these.

The technical features of the above examples can be combined in any way. For conciseness of description, not all possible combinations of the technical features in the examples described above are described. However, these combinations should be within the scope of the description as long as no contradiction occurs in the combinations of these technical features.

The above examples represent only several examples of the present disclosure, which are described specifically in detail, but should not be construed thus as limitations on the scope of the present disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. A method comprising:
acquiring, by a feed-forward microphone on a headphone, a first audio signal;
acquiring, by a feed-back microphone on the headphone, a second audio signal;
determining, based on the first audio signal, a scene type of a scene where the headphone is located;
obtaining a target effect audio signal based on the scene type;
determining current spectrum relationship information between the first audio signal and the second audio signal, and target spectrum relationship information between the first audio signal and the target effect audio signal;
adjusting filter parameters of the headphone based on the current spectrum relationship information and the target spectrum relationship information;
re-acquiring the second audio signal using the adjusted filter parameters; and
based on determining that a signal error between the re-acquired second audio signal and the target effect audio signal is greater than or equal to a threshold, performing the acquiring the first audio signal step and the acquiring the second audio signal step, until the signal error between the re-acquired second audio signal and the target effect audio signal is below the threshold.

2. The method of claim 1, further comprising:
determining a target detection frequency band based on a previous scene type; and
based on determining that a signal amplitude change value of the first audio signal in the target detection frequency band is greater than a preset change threshold, determining that the scene type has changed, and performing the determining the scene type step; and
based on determining that the signal amplitude change value of the first audio signal in the target detection frequency band is not greater than the preset change threshold, determining that the scene type has not changed, and determining the previous scene type as the scene type of the scene where the headphone is located.

3. The method of claim 1, wherein the determining the scene type comprises:
extracting an audio signal feature from the first audio signal; and
determining the scene type of the scene where the headphone is located based on the audio signal feature.

4. The method of claim 1, wherein the adjusting comprises:
calculating a deviation between the current spectrum relationship information and the target spectrum relationship information to obtain first spectrum deviation information;
determining first parameter adjustment information corresponding to the filter parameters of the headphone based on a preset transfer function and the first spectrum deviation information; and
adjusting the filter parameters of the headphone based on the first parameter adjustment information.

5. The method of claim 4, wherein the first parameter adjustment information comprises a parameter adjustment amplitude and a parameter adjustment direction; and
the determining the first parameter adjustment information comprises:
determining, based on the first spectrum deviation information, a signal amplitude deviation between the first audio signal and the second audio signal in each of preset frequency bands; and
determining, based on the signal amplitude deviation in each of the preset frequency bands and the preset transfer function, the parameter adjustment amplitude and the parameter adjustment direction of the filter parameters of the headphone in each of the preset frequency bands.

6. The method of claim 1, further comprising:
adjusting a signal amplitude of the target effect audio signal in response to a first adjustment instruction; or
adjusting a signal amplitude distribution of the target effect audio signal in each of preset frequency bands in response to a second adjustment instruction.

7. The method of claim 1, further comprising:
detecting a wearing state of the headphone; and
based on determining that the wearing state of the headphone has changed, performing the determining the current spectrum relationship information, and the target spectrum relationship information step.

8. The method of claim 1, wherein the target effect audio signal comprises at least one of:
an active noise reduction effect audio signal of a full frequency band;
a transparency effect audio signal of the full frequency band; or
active noise reduction effect audio signals of multiple first frequency bands and transparency effect audio signals of multiple second frequency bands, wherein the multiple first frequency bands and the multiple second frequency bands form the full frequency band.

9. The method of claim 1, wherein:
the headphone comprises a plurality of feed-forward microphones corresponding to a plurality of sound transmission directions,
the first audio signal comprises external sound signals in the plurality of sound transmission directions,
the current spectrum relationship information comprises first spectrum relationship information corresponding to the external sound signals in the plurality of sound transmission directions, and the target spectrum relationship information comprises second spectrum relationship information corresponding to the external sound signals in the plurality of sound transmission directions; and
the adjusting the filter parameters of the headphone comprises:
calculating a deviation between the first spectrum relationship information and the second spectrum relationship information in each of the plurality of sound transmission directions to obtain second spectrum deviation information in each of the plurality of sound transmission directions;
determining second parameter adjustment information corresponding to the filter parameters of the headphone in each of the plurality of sound transmission directions based on the second spectrum deviation information in each of the plurality of sound transmission directions; and
adjusting the filter parameters of the headphone in each of the plurality of sound transmission directions based on the second parameter adjustment information.

10. A headphone comprising:
a feed-forward microphone;
a feed-back microphone;
one or more processors; and
memory storing instructions that, when executed by the one or more processors, cause:
the feed-forward microphone to acquire a first audio signal;
the feed-back microphone to acquire a second audio signal; and
the headphone to:
determine, based on the first audio signal, a scene type of a scene where the headphone is located;
obtain a target effect audio signal based on the scene type;
determine current spectrum relationship information between the first audio signal and the second audio signal, and target spectrum relationship information between the first audio signal and the target effect audio signal;
adjust filter parameters of the headphone based on the current spectrum relationship information and the target spectrum relationship information;
re-acquire the second audio signal using the adjusted filter parameters; and
based on determining that a signal error between the re-acquired second audio signal and the target effect audio signal is greater than or equal to a threshold, perform the acquiring the first audio signal step and the acquiring the second audio signal step, until the signal error between the re-acquired second audio signal and the target effect audio signal is below the threshold.

11. The headphone of claim 10, wherein the instructions, when executed by the one or more processors, cause the headphone to:
determine a target detection frequency band based on a previous scene type; and
based on determining that a signal amplitude change value of the first audio signal in the target detection frequency band is greater than a preset change threshold, determine that the scene type has changed, and performing the determining the scene type step; and
based on determining that the signal amplitude change value of the first audio signal in the target detection frequency band is not greater than the preset change threshold, determine that the scene type has not changed, and determining the previous scene type as the scene type of the scene where the headphone is located.

12. The headphone of claim 10, wherein the instructions, when executed by the one or more processors, cause the headphone to determine the scene type by:
extracting an audio signal feature from the first audio signal; and
determining the scene type of the scene where the headphone is located based on the audio signal feature.

13. The headphone of claim 10, wherein the instructions, when executed by the one or more processors, cause the headphone to adjust the filter parameters by:
calculating a deviation between the current spectrum relationship information and the target spectrum relationship information to obtain first spectrum deviation information;
determining first parameter adjustment information corresponding to the filter parameters of the headphone based on a preset transfer function and the first spectrum deviation information; and
adjusting the filter parameters of the headphone based on the first parameter adjustment information.

14. The headphone of claim 13, wherein the first parameter adjustment information comprises a parameter adjustment amplitude and a parameter adjustment direction; and wherein the instructions, when executed by the one or more processors, cause the headphone to determine the first parameter adjustment information by:
determining, based on the first spectrum deviation information, a signal amplitude deviation between the first audio signal and the second audio signal in each of preset frequency bands; and
determining, based on the signal amplitude deviation in each of the preset frequency bands and the preset transfer function, the parameter adjustment amplitude and the parameter adjustment direction of the filter parameters of the headphone in each of the preset frequency bands.

15. The headphone of claim 10, wherein the instructions, when executed by the one or more processors, cause the headphone to:
adjust a signal amplitude of the target effect audio signal in response to a first adjustment instruction; or
adjust a signal amplitude distribution of the target effect audio signal in each of preset frequency bands in response to a second adjustment instruction.

16. The headphone of claim 10, wherein the instructions, when executed by the one or more processors, cause the headphone to:
detect a wearing state of the headphone; and
based on determining that the wearing state of the headphone has changed, perform determining the current spectrum relationship information, and the target spectrum relationship information step.

17. The headphone of claim 10, wherein the target effect audio signal comprises at least one of:
an active noise reduction effect audio signal of a full frequency band;
a transparency effect audio signal of the full frequency band; or
active noise reduction effect audio signals of multiple first frequency bands and transparency effect audio signals of multiple second frequency bands, wherein the multiple first frequency bands and the multiple second frequency bands form the full frequency band.

18. The headphone of claim 10, further comprising a plurality of feed-forward microphones corresponding to a plurality of sound transmission directions, wherein:
the first audio signal comprises external sound signals in the plurality of sound transmission directions,
the current spectrum relationship information comprises first spectrum relationship information corresponding to the external sound signals in the plurality of sound transmission directions, and the target spectrum relationship information comprises second spectrum relationship information corresponding to the external sound signals in the plurality of sound transmission directions; and
the instructions, when executed by the one or more processors, cause the headphone to adjust the filter parameters of the headphone by:
calculating a deviation between the first spectrum relationship information and the second spectrum relationship information in each of the plurality of sound transmission directions to obtain second spectrum deviation information in each of the plurality of sound transmission directions;
determining second parameter adjustment information corresponding to the filter parameters of the headphone in each of the plurality of sound transmission directions based on the second spectrum deviation information in each of the plurality of sound transmission directions; and
adjusting the filter parameters of the headphone in each of the plurality of sound transmission directions based on the second parameter adjustment information.

19. A non-transitory computer-readable medium storing instructions that, when executed, cause:
acquiring, by a feed-forward microphone on a headphone, a first audio signal;
acquiring, by a feed-back microphone on the headphone, a second audio signal;
determining, based on the first audio signal, a scene type of a scene where the headphone is located;
obtaining a target effect audio signal based on the scene type;
determining current spectrum relationship information between the first audio signal and the second audio signal, and target spectrum relationship information between the first audio signal and the target effect audio signal;
adjusting filter parameters of the headphone based on the current spectrum relationship information and the target spectrum relationship information;
re-acquiring the second audio signal using the adjusted filter parameters; and
based on determining that a signal error between the re-acquired second audio signal and the target effect audio signal is greater than or equal to a threshold, performing the acquiring the first audio signal step and the acquiring the second audio signal step, until the signal error between the re-acquired second audio signal and the target effect audio signal is below the threshold.

20. The non-transitory computer-readable medium of claim 19, wherein the instructions, when executed, cause the adjusting the filter parameters by:
calculating a deviation between the current spectrum relationship information and the target spectrum relationship information to obtain first spectrum deviation information;
determining first parameter adjustment information corresponding to the filter parameters of the headphone based on a preset transfer function and the first spectrum deviation information; and
adjusting the filter parameters of the headphone based on the first parameter adjustment information.
